(19) United States
(12) Patent Application Publication
(10) Pub. No.: US 2021/0237115 A1
(43) Pub. Date: Aug. 5, 2021

(54) COATING NOZZLE CLEANING METHOD AND DEVICE

(71) Applicant: HONDA MOTOR CO., LTD., Tokyo (JP)

(72) Inventors: Koji ODA, Tochigi (JP); Takayuki HOSHINO, Tochigi (JP); Hidekazu RYU, Tochigi (JP); Satoshi KITSUGI, Tochigi (JP)

(21) Appl. No.: 17/050,452

(22) PCT Filed: May 8, 2019
(86) PCT No.: PCT/JP2019/018346

§ 371 Date: Oct. 25, 2020

(30) Foreign Application Priority Data
May 11, 2018 (JP) 2018-092047

(51) Int. Cl. B05C 11/10; B05C 5/00; B05D 1/26

(52) U.S. Cl. CPC B05C 11/10; B05D 1/26; B05C 5/00

(57) ABSTRACT

Provided are a cleaning method and a device for a coating nozzle with which it is possible to cleanly remove a coating agent that has become attached to the coating nozzle. The cleaning device for a coating nozzle cleans the tip of a translatable coating nozzle. The cleaning device for the coating nozzle is provided with a cleaning pad having grooves configured to sandwich the coating nozzle. The grooves comprise first grooves extending in a first direction, and second grooves extending in a second direction facing a direction substantially at right angle to the first direction.

### TECHNICAL FIELD

The present invention relates to a coating nozzle cleaning method and device.

### BACKGROUND ART

As shown in FIG. 7, a workpiece W such as an outer panel may be coated with an adhesive 101 by a robot arm 100 having a tip to which a coating nozzle N is attached. The adhesive 101 adheres on the coating nozzle N, and hence it is necessary to remove the adhesive 101 during an operation or the like. In Patent Document 1, an adhesive removing device for a coating nozzle is disclosed in which a tip of the coating nozzle is pressed onto a band-shaped body to be wound on a reel, to remove an adhesive adhering on the tip of the coating nozzle.

Patent Document 1: Japanese Unexamined Utility Model Application, Publication No.H05-085466

### DISCLOSURE OF THE INVENTION

### Problems to be Solved by the Invention

In the above device, an entire periphery of a tip of a coating nozzle is not pressed onto a band-shaped body, and an adhesive adhering on a portion pressed with the band-shaped body can be removed, but an adhesive adhering on a portion that is not pressed with the band-shaped body cannot be removed.

It is considered that the coating nozzle is rotated about an axis, to eliminate the portion that is not pressed with the band-shaped body, and all the adhesive is removed. However, the device cannot be applied to a structure where the coating nozzle does not rotate about the axis. Furthermore, if a structure including the coating nozzle rotated about the axis to remove the adhesive is employed, weight and cost of the device increase, and a measure against the increase is required.

The present invention has been developed in view of the above problems, and an object thereof is to provide a cleaning method and device for a coating nozzle, with which an adhesive adhering on the coating nozzle can be cleanly removed.

### Means for Solving the Problems

(1) A cleaning device for a coating nozzle according to the present invention (e.g., an after-mentioned cleaning device 1 for a coating nozzle) is a cleaning device that cleans a tip of a translatable coating nozzle (e.g., an after-mentioned coating nozzle N), comprising a cleaning pad (e.g., an after-mentioned cleaning pad 20) provided with grooves (e.g., after-mentioned grooves 21a, 21b, 22a, 22b) configured to be able to sandwich the coating nozzle, the grooves including first grooves (e.g., after-mentioned first grooves 21a, 21b) extending in a first direction (e.g., an after-mentioned first direction D1), and second grooves (e.g., after-mentioned second grooves 22a, 22b) extending in a second direction (e.g., an after-mentioned second direction D2) facing a direction substantially perpendicular to the first direction D1.

According to the present invention, the coating nozzle is sandwiched between the first grooves, and the coating nozzle is moved along the first grooves, so that left and right portions of the coating nozzle can be cleaned. Furthermore, front and rear portions located during the cleaning with the first grooves can be also cleaned by sandwiching the coating nozzle between the second grooves, and moving the coating nozzle along the second grooves. Consequently, the cleaning can be performed only by translational movement of the coating nozzle. As a result, an adhesive adhering on the coating nozzle can be cleanly removed while suppressing weight increase and cost increase of the device.

(2) In the present invention, it is preferable that the cleaning pad includes a plurality of small cleaning pads (e.g., after-mentioned small cleaning pads 20A, 20B, 20C, 20D), and each of the grooves is formed in a boundary between the small cleaning pads.

According to the present invention, a cleaning pad having a simple structure while including the grooves can be configured.

(3) In the present invention, it is preferable that four of the small cleaning pads of the cleaning pad are combined to form two sets comprising the first grooves and the second grooves, and the two sets include a first set for initial cleaning and a second set for finish cleaning.

According to the present invention, the grooves are divided for the initial cleaning and for the finish cleaning, so that a replacement span of the whole cleaning pad can be lengthened, and the coating nozzle can be cleaned up.

(4) It is preferable that the present invention further comprises a base (e.g., an after-mentioned base 11) that supports the cleaning pad from below, and a lid (e.g., an after-mentioned lid 12) attached to the base to cover the cleaning pad from above and including an opening (e.g., an after-mentioned slit 12a) from which the grooves are exposed.

(5) A cleaning method for a coating nozzle according to the present invention is a cleaning method for a coating nozzle of cleaning a tip of a translatable coating nozzle (e.g., an after-mentioned coating nozzle N), comprising a cleaning pad preparing step (e.g., an after-mentioned cleaning pad preparing step S100) of preparing a cleaning pad (e.g., an after-mentioned cleaning pad 20) including, as grooves (e.g., after-mentioned grooves 21a, 21b, 22a, 22b) configured to be able to sandwich the coating nozzle, first grooves (e.g., after-mentioned first grooves 21a, 21b) extending in a first direction (e.g., an after-mentioned first direction D1), and second grooves (e.g., after-mentioned second grooves 22a, 22b) extending in a second direction (e.g., an after-mentioned second direction D2) facing a direction substantially perpendicular to the first direction; a first cleaning step (e.g., after-mentioned first cleaning steps S110, S130) of moving the coating nozzle in the first direction in the first grooves, after the cleaning pad preparing step; and a second cleaning step (e.g., after-mentioned second cleaning steps S120, S140) of moving the coating nozzle in the second direction in the second grooves, after the first cleaning step.

According to the present invention, the coating nozzle is sandwiched between the first grooves, and the coating nozzle is moved along the first grooves, so that left and right portions of the coating nozzle can be cleaned. Furthermore, front and rear portions located during the cleaning with the first grooves can be cleaned also by sandwiching the coating nozzle between the second grooves, and moving the coating nozzle along the second grooves. Consequently, the cleaning can be performed only by translational movement of the coating nozzle. As a result, an adhesive adhering on the coating nozzle can be cleanly removed while suppressing weight increase and cost increase of the device.

(6) In the present invention, it is preferable that in at least one of the first cleaning step and the second cleaning step, a lower end of the coating nozzle is brought into contact with the cleaning pad, and the coating nozzle is moved to slide into the grooves.

According to the present invention, dirt on the lower end of the coating nozzle can be well removed.

(7) In the present invention, it is preferable that the cleaning pad forms two sets comprising the first grooves and the second grooves, the first cleaning step and the second cleaning step of a first time are performed with a first set of the two sets, and the first cleaning step and the second cleaning step of a second time are performed with a second set of the two sets, after the first cleaning step and the second cleaning step of the first time.

According to the present invention, finish cleaning can be performed.

### Effects of the Invention

According to the present invention, an adhesive adhering on a coating nozzle can be cleanly removed.

### BRIEF DESCRIPTION OF THE DRAWINGS

FIG. 1 is an appearance perspective view showing a cleaning device for a coating nozzle according to an embodiment of the present invention;

FIG. 2 is a cross-sectional view showing the cleaning device for the coating nozzle seen in an arrow II-II direction of FIG. 1;

FIG. 3 is a flowchart explaining a procedure of a cleaning method for a coating nozzle;

FIG. 4 is a schematic diagram of the cleaning device for the coating nozzle, showing a first cleaning step and a second cleaning step of a first time;

FIG. 5 is a schematic diagram of the cleaning device for the coating nozzle, showing a first cleaning step and a second cleaning step of a second time;

FIG. 6A is a schematic diagram of the cleaning device for the coating nozzle, explaining movement of the coating nozzle in the first cleaning step and the second cleaning step;

FIG. 6B is a schematic diagram of the cleaning device for the coating nozzle, explaining the movement of the coating nozzle in the first cleaning step and the second cleaning step;

FIG. 6C is a schematic diagram of the cleaning device for the coating nozzle, explaining the movement of the coating nozzle in the first cleaning step and the second cleaning step;

FIG. 6D is a schematic diagram of the cleaning device for the coating nozzle, explaining the movement of the coating nozzle in the first cleaning step and the second cleaning step;

FIG. 7 is a schematic view showing a behavior that a workpiece is coated with an adhesive by a robot including a tip to which the coating nozzle is attached.

### PREFERRED MODE FOR CARRYING OUT THE INVENTION

Hereinafter, description will be made as to an embodiment of the present invention with reference to the drawings.

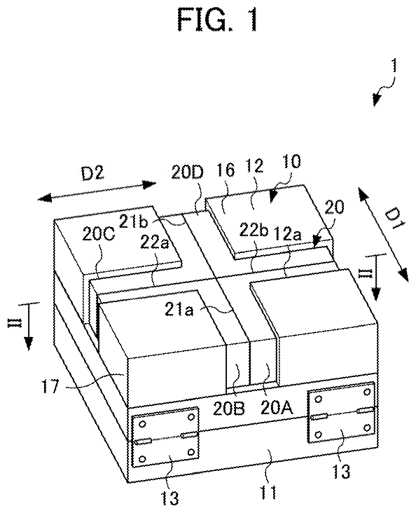

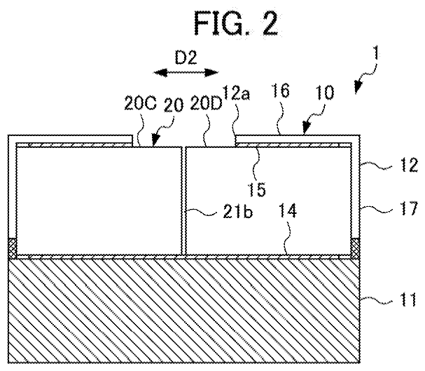

First, description will be made as to a configuration of a cleaning device 1 for a coating nozzle N with reference to FIG. 1 and FIG. 2. FIG. 1 is an appearance perspective view showing the cleaning device 1 for the coating nozzle N according to the embodiment of the present invention. FIG. 2 is a cross-sectional view showing the cleaning device 1 for the coating nozzle N seen in an arrow II-II direction of FIG. 1.

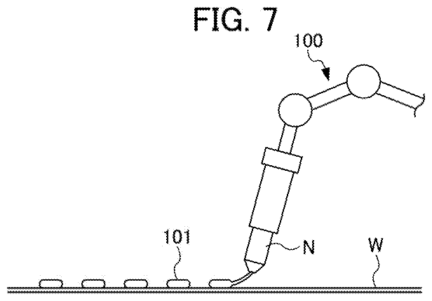

As shown in FIG. 1 and FIG. 2, the cleaning device 1 for the coating nozzle N according to the present invention is configured to clean a tip of the translatable coating nozzle N. The cleaning device 1 for the coating nozzle N is disposed in a movement range of the coating nozzle N that is movable by a robot arm 100 (see FIG. 7) that is a moving device. Specifically, the cleaning device 1 for the coating nozzle N comprises a housing 10 and a cleaning pad 20.

The housing 10 houses the cleaning pad 20, to position the cleaning pad 20. Specifically, the housing 10 comprises a base 11, a lid 12, a pair of hinges 13, a draw latch (not shown) and non-slip tapes 14, 15.

The base 11 is a rectangular flat plate that supports the cleaning pad 20 from below. The non-slip tape 14 is affixed to an upper surface of the base 11, and the cleaning pad 20 is fixed with the non-slip tape 14. The non-slip tape 14 of the present embodiment is processed to generate roughness on a surface of the tape that is in contact with the cleaning pad 20.

The pair of hinges 13 are attached to one side of the base 11, and the lid 12 is openably/closably coupled to the base 11 via the pair of hinges 13. The draw latch (not shown) is attached to the other side of the base 11, the draw latch (not shown) is closed to fix the lid 12 to the base 11, and the draw latch (not shown) is opened so that the lid 12 is openable relative to the base 11.

The lid 12 includes an upper plate 16 having an outer rectangular shape, and a side plate 17 extending downward from an edge of the upper plate 16. The non-slip tape 15 is affixed to a lower surface of the upper plate 16, and the cleaning pad 20 is fixed via the non-slip tape 15. The non-slip tape 15 of the present embodiment is processed to generate roughness on a surface of the tape that is in contact with the cleaning pad 20.

A slit 12a having a cross shape in planar view is formed from the upper plate 16 to the side plate 17 in the lid 12. Grooves 21a, 21b, 22a, 22b in the cleaning pad 20 housed in the housing 10 are exposed from the slit 12a. The pair of hinges 13 are attached below one side plate 17 of the lid 12, and the lid 12 is openably/closably coupled to the base 11 via the pair of hinges 13. The draw latch (not shown) is attached below the other side plate 17 of the lid 12, the draw latch (not shown) is closed to fix the lid 12 to the base 11, and the draw latch (not shown) is opened so that the lid 12 is openable relative to the base 11. Thus, the lid 12 is attached to the base 11, to cover the cleaning pad 20 fixed to the base 11 from above, and includes the slit (opening) 12a from which the grooves 21a, 21b, 22a, 22b are exposed.

The pair of hinges 13 are attached to the base 11 and also to the lid 12, respectively, on one side of the housing 10, and the lid 12 is openably/closably coupled to the base 11 via the pair of hinges 13. The draw latch (not shown) is attached to the base 11 and also to the lid 12 on the other side of the housing 10, the draw latch (not shown) is closed to fix the lid 12 to the base 11, and the draw latch (not shown) is opened so that the lid 12 is openable relative to the base 11.

The non-slip tape 14 is attached to the upper surface of the base 11, to fix the cleaning pad 20 to the upper surface of the base 11. The non-slip tape 15 is attached to the lower surface of the upper plate 16 in the lid 12, to fix the cleaning pad 20 to the lower surface of the upper plate 16. That is, the cleaning pad 20 is sandwiched between the non-slip tapes 14 and 15 in an up-down direction, and housed inside the housing 10.

The cleaning pad 20 is provided with the grooves 21a, 21b, 22a, 22b configured to be able to sandwich the coating nozzle N. Specifically, the cleaning pad 20 includes a plurality of small cleaning pads 20A, 20B, 20C, 20D. More specifically, four small cleaning pads 20A, 208, 20C, 20D of the cleaning pad 20 are combined to form the grooves 21a, 21b, 22a, 22b in a boundary between the small cleaning pads 20A, 208, 20C, 20D.

The grooves 21a, 21b, 22a, 22b includes first grooves 21a, 21b extending in a first direction D1, and second grooves 22a, 22b extending in a second direction D2 facing a direction substantially perpendicular to the first direction D1. The first groove 21a and the second groove 22a constitute a first set for initial cleaning. The first groove 21b and the second groove 22b constitute a second set for finish cleaning.

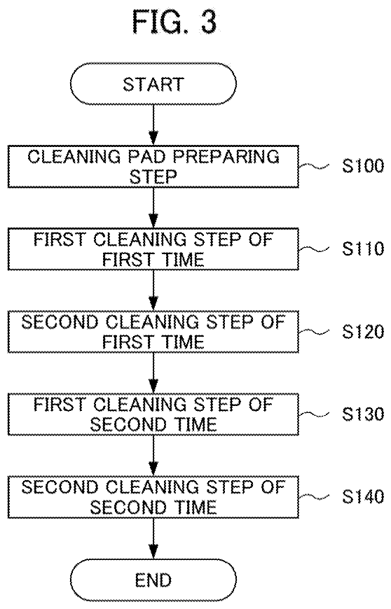

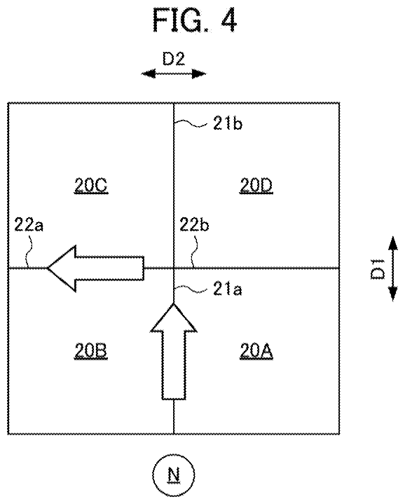

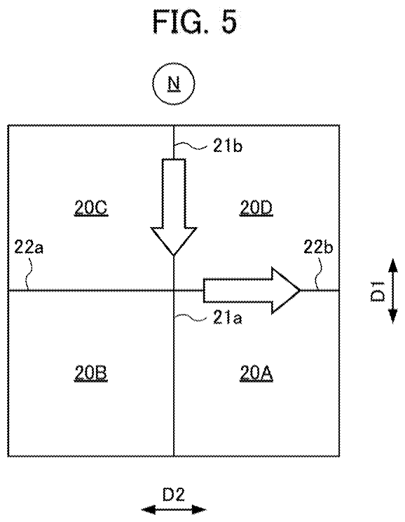

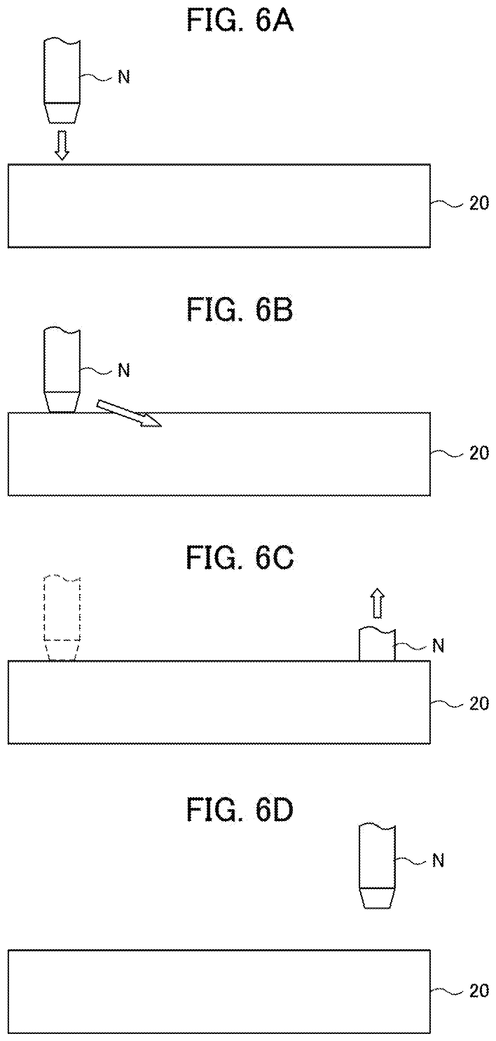

Next, description will be made as to a cleaning method for the coating nozzle N by use of the cleaning device 1 for the coating nozzle N with reference to FIG. 3, FIG. 4 and FIG. 5. FIG. 3 is a flowchart explaining a procedure of the cleaning method for the coating nozzle N. FIG. 4 is a schematic diagram of the cleaning device 1 for the coating nozzle N, explaining a first cleaning step S110 and a second cleaning step S120 of a first time. FIG. 5 is a schematic diagram of the cleaning device 1 for the coating nozzle N, explaining a first cleaning step S130 and a second cleaning step S140 of a second time. FIG. 6A to FIG. 6D are schematic views of the cleaning device 1 for the coating nozzle N, explaining movement of the coating nozzle N in the first cleaning steps S110, S130 and the second cleaning steps S120, S140. Note that in FIG. 4 to FIG. 6D, the lid 12 is omitted.

As shown in FIG. 3, the cleaning method for the coating nozzle N by use of the cleaning device 1 for the coating nozzle N according to the present invention is a method of cleaning a tip of the translatable coating nozzle N. Specifically, the procedure of the cleaning method for the coating nozzle N comprises the cleaning pad preparing step S100, the first cleaning step S110 of the first time, the second cleaning step S120 of the first time, the first cleaning step S130 of the second time, and the second cleaning step S140 of the second time.

The cleaning pad preparing step S100 is a step of preparing the cleaning pad 20 including, as the grooves 21a, 21b, 22a, 22b configured to be able to sandwich the coating nozzle N, the first grooves 21a, 21b extending in the first direction D1, and the second grooves 22a, 22b extending in the second direction D2 facing the direction substantially perpendicular to the first direction D1.

As shown in FIG. 4, the first cleaning step S110 of the first time is a step of moving the coating nozzle N in the first direction D1 in the first groove 21a, after the cleaning pad preparing step S100.

The second cleaning step S120 of the first time is a step of moving the coating nozzle N in the second direction D2 in the second groove 22a, after the first cleaning step S110 of the first time. Note that an orientation itself of the coating nozzle N does not change during the movement in the second direction D2.

As shown in FIG. 5, the first cleaning step S130 of the second time is a step of moving the coating nozzle N in the first direction D1 in the first groove 21b, after the second cleaning step S120 of the first time.

The second cleaning step S140 of the second time is a step of moving the coating nozzle N in the second direction D2 in the second groove 22b, after the first cleaning step S130 of the second time. Note that the orientation itself of the coating nozzle N does not change during the movement in the direction D2.

In a case of the movement only in the direction D1 or the movement only in the direction D2, the coating nozzle N pushes and divides the groove and proceeds, and hence opposite sides in a proceeding direction satisfactorily come in contact with the cleaning pad 20, but front and rear regions in the proceeding direction are hard to come in contact. With the proceeding of the coating nozzle N, the cleaning pad 20 is pushed and divided on the opposite sides, and a gap is made between a front or rear portion of the coating nozzle N and the cleaning pad 20.

Therefore, in the present embodiment, the cleaning of each of the first time and the second time includes a process of changing the direction D1 and the direction D2, and the coating nozzle N is moved in two directions. Consequently, front and rear regions located in the proceeding direction during the movement in the direction D1 are located on the opposite sides in the proceeding direction during the movement in the direction D2. Therefore, through the two directions, an entire periphery of the coating nozzle N can be cleaned without any leakage by the cleaning pad 20.

Here, a case of moving the coating nozzle N without changing its height is considered. The coating nozzle N pushes the grooves 21a, 21b, 22a, 22b on the opposite sides in the proceeding direction inside the grooves 21a, 21b, 22a, 22b, and a gap is formed between a lower surface of the coating nozzle N and the cleaning pad 20. If the coating nozzle N is moved without changing the height, this gap is maintained.

Thus, in the present embodiment, as shown in FIG. 6A to FIG. 6D, through each of the first cleaning steps S110, S130 and the second cleaning steps S120, S140, a lower end of the coating nozzle N is brought into contact with the cleaning pad 20 (see from FIG. 6A to FIG. 6B), the coating nozzle N is moved to slide into the grooves 21a, 21b, 22a, 22b (see from FIG. 6B to FIG. 6C), and then the coating nozzle N is retracted upward from the cleaning pad 20 (see from FIG. 6C to FIG. 6D). Through the steps, the lower end of the coating nozzle N is slid downward from above into the grooves 21a, 21b, 22a, 22b, and in a process of moving downward, the lower surface of the coating nozzle N can be further satisfactorily in contact with the cleaning pad 20.

The cleaning device 1 for the coating nozzle N according to the present embodiment exhibits the following effects. First, according to the present embodiment, the coating nozzle N is sandwiched between the first grooves 21a and 21b, and the coating nozzle N is moved along the first grooves 21a, 21b, so that left and right portions of the coating nozzle N can be cleaned. Furthermore, front and rear portions located during the cleaning with the first grooves 21a, 21b can be also cleaned by sandwiching the coating nozzle N between the second grooves 22a and 22b and moving the coating nozzle N along the second grooves 22a, 22b. Consequently, the cleaning can be performed only by translational movement of the coating nozzle N. As a result, an adhesive adhering on the coating nozzle N can be cleanly removed while suppressing weight increase and cost increase of the device.

Furthermore, according to the present embodiment, the cleaning pad 20 having a simple structure while including the grooves 21a, 21b, 22a, 22b can be configured.

Additionally, according to the present embodiment, the grooves 21a, 21b, 22a, 22b are divided for the initial cleaning and for the finish cleaning, so that a replacement span of the whole cleaning pad 20 can be lengthened, and the coating nozzle N can be cleaned up.

Furthermore, according to the present embodiment, in at least one of the first cleaning steps S110, S130 and the second cleaning steps S120, S140, the lower end of the coating nozzle N is brought into contact with the cleaning pad 20, and the coating nozzle N is moved to slide into the grooves 21a, 21b, 22a, 22b, so that dirt on the lower end of the coating nozzle N can be well removed.

Additionally, according to the present embodiment, the first cleaning step S110 and the second cleaning step S120 of the first time are performed with a set comprising the first groove 21a and the second groove 22a, and the first cleaning step S130 and the second cleaning step S140 of the second time are performed with a set comprising the first groove 21b and the second groove 22b, so that the finish cleaning can be performed.

Note that the present invention is not limited to the above embodiment, and the present invention includes modification, improvement and the like in a scope of capable of achieving an object of the present invention.

In the present embodiment, the second direction D2 in which the second grooves 22a, 22b extend is the direction substantially perpendicular to the first direction in which the first grooves 21a, 21b extend, but “substantially perpendicular” in the present invention is concept including not only a strict right angle but also a crossing angle at which the adhesive adhering on the coating nozzle N can be cleanly removed, such as 60 degrees or 70 degrees.

According to the present embodiment, in each of the first cleaning steps S110, S130 and the second cleaning steps S120, S140, the lower end of the coating nozzle N is brought into contact with the cleaning pad 20, the coating nozzle N is moved to slide into the grooves 21a, 21b, 22a, 22b, and then the coating nozzle N is retracted upward from the cleaning pad 20, but in the present invention, in at least one of the first cleaning steps S110, S130 and the second cleaning steps S120, S140, the lower end of the coating nozzle N may be brought into contact with the cleaning pad 20, the coating nozzle N may be moved to slide into the groove 21a, 21b, 22a or 22b, and then the coating nozzle N may be retracted upward from the cleaning pad 20.

The present embodiment includes a configuration where the non-slip tapes 14, 15 are arranged on upper and lower surfaces of the cleaning pad 20, but may include a configuration where the non-slip tapes 14, 15 are also arranged on inner side surfaces of the lid 12 (surfaces facing side surfaces of the cleaning pad 20). Furthermore, the non-slip tapes 14, 15 may be omitted. The moving device that moves the coating nozzle N is not limited to the robot arm 100. For example, a table mechanism comprising a lift device capable of moving the coating nozzle N in an XY plane and moving the coating nozzle N in an up-down direction may be provided.

### EXPLANATION OF REFERENCE NUMERALS

1 cleaning device

10 housing

11 base

12 lid

12a slit (opening)

13 hinge

14 and 15 non-slip tape

16 upper plate

17 side plate

20 cleaning pad

20A, 20B, 20C, and 20D small cleaning pad

21a and 21b first groove (groove)

22a and 22b second groove (groove)

N coating nozzle

D1 first direction

D2 second direction

S100 cleaning pad preparing step

5110 first cleaning step of a first time

S120 second cleaning step of the first time

S130 first cleaning step of a second time

S140 second cleaning step of the second time

1. A cleaning device for a coating nozzle that cleans a tip of a translatable coating nozzle, comprising:
a cleaning pad provided with grooves configured to be able to sandwich the coating nozzle,
the grooves including first grooves extending in a first direction, and second griives extending in a second direction facing a direction substantially perpendicular to the first direction.

2. The cleaning device for the coating nozzle according to claim 1, wherein the cleaning pad includes a plurality of small cleaning pads, and
each of the grooves is formed in a boundary between the small cleaning pads.

3. The cleaning device for the coating nozzle according to claim 2, herein four of the small cleaning pads of the cleaning pad are combined to form two sets comprising the first grooves and the second grooves, and
the two sets include a first set for initial cleaning and a second set for finish cleaing.

4. The cleaning device for the coating nozzle according to claim 1, further comprising: a base that supports the cleaning pad from below; and
a lid attached to the base to cover the cleaning pad from above and including an opening from which the grooves are exposed.

5. A cleaning method for a coating nozzle of cleaning a tip of a translatable coating nozzle, comprising:
a cleaning pad preparing step of preparing a cleaning pad including, as grooves configured to be able to sandwich the coating nozzle, first grooves extending in a first direction, and second grooves extending in a second direction facing a direction substantially perpendicular to the first direction;
a first cleaning step of moving the coating nozzle in the first direction in the first grooves, after the cleaning pad preparing step; and
a second cleaning step of moving the coating nozzle in the second direction in the second grooves, after the first cleaning step.

6. The cleaning method for the coating nozzle according to claim 5, wherein in at least one of the first cleaning step and the second cleaning step, a lower end of the coating nozzle is brought into contact with the cleaning pad, and the coating nozzle is moved to slide into the grooves.

7. The cleaning method for the coating nozzle according to claim 5, wherein the cleaning pad forms two sets comprising the first grooves and the second grooves,
the first cleaning step and the second cleaning step of a first time are performed with a first set of the two sets, and
the first cleaning step and the second cleaning step of a second time are performed with a second set of the two sets, after the first cleaning step and the second cleaning step of the first time.
